(19) United States
(12) Patent Application Publication
(10) Pub. No.: US 2025/0001722 A1
(43) Pub. Date: Jan. 2, 2025

(54) UTILITY POLE ASSEMBLY AND LAMINATE STRUCTURE FOR A UTILITY POLE ASSEMBLY

(71) Applicant: RS Technologies Inc., Tilbury, Ontario (CA)

(72) Inventors: Shawn VAN HOEK-PATTERSON, Victoria (CA); Mingzong ZHANG, Calgary (CA); Joel TENNISON, Calgary (CA); Mark FORGET, Windsor (CA); Scott T. HOLMES, Oxford, PA (US)

(21) Appl. No.: 18/694,945

(22) PCT Filed: Sep. 20, 2022
(86) PCT No.: PCT/CA2022/051392

§ 371 Date: Mar. 22, 2024

Related U.S. Application Data
(60) Provisional application No. 63/248,366, filed on Sep. 24, 2021.
(60) Provisional application No. 63/305,078, filed on Jan. 31, 2022.

(51) Int. Cl. B32B 5/12; B29C 70/24; B29C 70/34; B29C 70/52; B29C 70/54; B29K 75/00; B29K 309/08; B29L 31/00; B32B 1/08; B32B 5/02; B32B 7/02; E04H 12/02

(52) U.S. Cl. CPC B32B 5/12; B29C 70/24; B29C 70/34; B29C 70/523; B29C 70/541; B32B 1/08; B32B 5/024; B32B 7/02; E04H 12/02; B29K 2075/00; B29K 2309/08; B29K 2995/0055; B29L 2031/766; B32B 2260/023; B32B 2260/046; B32B 2262/101; B32B 2307/71; B32B 2307/718; B32B 2597/00

(57) ABSTRACT

A utility pole assembly includes a utility pole having an inner core, and further includes a laminate structure surrounding the inner core. The laminate structure includes a reinforcing structure having fiber reinforcement, an outer layer surrounding the reinforcing structure, and a resin at least partially mixed with the reinforcing structure and the outer layer. The resin is resistant to ultraviolet (UV) radiation. A concentration of the resin in the outer layer is greater than a concentration of the resin in the reinforcing structure.

### FIELD OF THE DISCLOSURE

The present disclosure relates to a utility pole assembly and to laminate structure for a utility pole assembly. The disclosure further relates to a method of making a laminate structure suitable for a utility pole assembly.

### Background to the Disclosure

Existing pultruded utility poles generally exhibit a number of drawbacks. For example, such poles typically suffer from poor ultraviolet (UV) weathering performance, low durability, low buckling stability, and inadequate deflection performance when compared to equivalent wood products. As a result, their lifespan can be limited to 25-50 years.

Characteristic resin materials of existing pultruded poles include polyesters, vinyl ester epoxies, and hybrid systems that must be loaded with UV inhibitors and UV absorbers to withstand outdoor exposure to UV and the elements. These resins may use low molecular weight monomers, such as styrene, that add additional processing and chemical exposure hazards during production and can also be present in a residual form after production due to excess monomer, leading to further degradation when, over time, low molecular weight species migrate out of the structure.

To overcome the inherent UV stability limitations of these resins, existing pultruded poles often incorporate secondary polymer veil materials, typically polyester or nylon, that cover the outside of the pole laminate so as to reflect, absorb, or otherwise block or shade the UV energy from reaching the underlying fiberglass. However, once degraded or damaged, the veils offer little UV protection to the underlying fiberglass.

Existing utility poles also may use coatings applied in-line or secondarily to the pole surface. Such coatings must have adequate surface preparation and bonding to perform over the anticipated lifespan of the pole. However, industrial coating performance in outdoor applications is typically limited to a lifespan of 15-25 years, and in some environmental conditions this unreinforced coating may degrade in an accelerated manner and fail by cracking, crazing, blistering, or disbonding before the desired lifespan is achieved. Such premature coating degradation leads to poor durability of the product in the field.

### SUMMARY OF THE DISCLOSURE

According to a first aspect of the disclosure, there is provided a utility pole assembly comprising: a utility pole comprising an inner core; and a laminate structure surrounding the inner core, comprising: a reinforcing structure comprising fiber reinforcement; an outer layer surrounding the reinforcing structure; and a resin at least partially mixed with the reinforcing structure and the outer layer, wherein the resin is resistant to ultraviolet (UV) radiation, and wherein a concentration of the resin in the outer layer is greater than a concentration of the resin in the reinforcing structure.

The inner core may be hollow.

The fiber reinforcement may comprise fiberglass.

The reinforcing structure may further comprise one or more fiber reinforcement layers. Each fiber reinforcement layer may comprise: first fiber elements extending in a first direction; and second fiber elements extending in a second direction at an angle to the first direction.

Each fiber reinforcement layer may comprise woven fiberglass or a fiberglass mat.

The first direction may be parallel to a longitudinal axis defined by the utility pole, and the second direction may be perpendicular to the first direction.

The second direction may be a circumferential direction relative to the longitudinal axis.

The one or more fiber reinforcement layers may comprise an outer fiber reinforcement layer and an inner fiber reinforcement layer.

The reinforcing structure may further comprise one or more fiberglass roving layers, and the outer and inner fiber reinforcement layers may be positioned on opposites sides of at least one of the one or more fiberglass roving layers.

At least one of the outer and inner fiber reinforcement layers may be in contact with the at least one of the one or more fiberglass roving layers.

For at least one of the one or more fiber reinforcement layers, an areal weight of the first fiber elements may be less than an areal weight of the second fiber elements.

The areal weight of the first fiber elements relative to the second fiber elements may be about 1:3.

A sum of an areal weight of the first fiber elements and an areal weight of the second fiber elements may be about 24 ounces per square yard.

The reinforcing structure may further comprise one or more fiberglass roving layers.

The reinforcing structure may further comprise one or more fiber reinforcement layers and one or more continuous filament mat layers. At least one of the one or more continuous filament mat layers may be interposed between at least one of the one or more fiberglass reinforcement layers and at least one of the one or more fiberglass roving layers.

The at least one of the one or more continuous filament mat layers may be in contact with the at least one of the one or more fiberglass roving layers.

The reinforcing structure may further comprise a fiberglass fabric layer.

An areal weight of the fiberglass fabric layer may be from about 4 to about 10 ounces per square yard.

The fiberglass fabric layer may comprise fiberglass fabric having a weave of from about 18×18 yarns to about 24×24 yarns per square inch.

The fiberglass fabric layer may be in contact with the outer layer.

The laminate structure may further comprise the following layers in a direction extending from an exterior surface of the laminate structure toward the inner core: the outer layer; a fiberglass fabric layer; an outer fiberglass roving layer; an outer fiber reinforcement layer; an outer continuous filament mat layer; a central fiberglass roving layer; an inner fiber reinforcement layer; an inner continuous filament mat layer; and an inner fiberglass roving layer.

The laminate structure may further comprise the following layers in a direction extending from an exterior surface of the laminate structure toward the inner core: the outer layer; a fiberglass fabric layer; an outer fiberglass roving layer; a fiber reinforcement layer; an outer continuous filament mat layer; an inner fiberglass roving layer; and an inner continuous filament mat layer.

The outer layer may consist of the resin.

A ratio of a weight percentage of the fiber reinforcement to a weight percentage of the resin may be from 75%-82% fiber reinforcement to 18%-25% resin.

The laminate structure may be formed by a pultrusion process.

The resin may comprise an aliphatic polyurethane resin.

The utility pole may comprise the laminate structure.

The utility pole assembly may not comprise a pole shield surrounding the utility pole.

The utility pole assembly may further comprise a pole shield surrounding the utility pole. The pole shield may comprise the laminate structure.

The pole shield may be secured to the utility pole using one or more fasteners.

The pole shield may extend partway along a length of the utility pole.

The pole shield may extend along an entirely of a length of the utility pole.

The utility pole may further comprise an aromatic polyurethane resin.

The utility pole may further comprise: a further laminate structure surrounding the inner core and comprising: a further reinforcing structure comprising fiber reinforcement; a further outer layer surrounding the further reinforcing structure; and a further resin at least partially mixed with the further reinforcing structure and the further outer layer, wherein a concentration of the further resin in the further outer layer is greater than a concentration of the further resin in the further reinforcing structure.

The further resin may comprise an aromatic polyurethane resin.

The pole shield may be formed by a filament winding process, and the utility pole may be formed by a pultrusion process.

According to a further aspect of the disclosure, there is provided a laminate structure for a utility pole assembly, comprising: a reinforcing structure comprising fiber reinforcement; an outer layer overlying the reinforcing structure; and a resin at least partially mixed with the reinforcing structure and the outer layer, wherein the resin is resistant to ultraviolet (UV) radiation, and wherein a concentration of the resin in the outer layer is greater than a concentration of the resin in the reinforcing structure.

According to a further aspect of the disclosure, there is provided a method of making a laminate structure, comprising: providing a fiber preform comprising fiber reinforcement; pulling the preform over a mandrel located inside a cavity of a die, so as to mould the preform; during the pulling, injecting a resin into the preform such that the resin is at least partially mixed with the preform, wherein the resin is resistant to ultraviolet (UV) radiation; and after the pulling and the injecting, allowing the preform to cure into a laminate structure surrounding a hollow inner core and comprising an outer layer overlying one or more layers of the fiber reinforcement, wherein, after the curing, a concentration of the resin in the outer layer is greater than a concentration of the resin in the one or more layers of the fiber reinforcement.

According to a further aspect of the disclosure, there is provided a method of repairing a utility pole assembly, the utility pole assembly comprising: a utility pole comprising an inner core; and a pole shield surrounding the utility pole and comprising: a reinforcing structure comprising fiber reinforcement; an outer layer surrounding the reinforcing structure; and a resin at least partially mixed with the reinforcing structure and the outer layer, wherein: the resin is resistant to ultraviolet (UV) radiation; and a concentration of the resin in the outer layer is greater than a concentration of the resin in the reinforcing structure, wherein the method comprises: removing at least a portion of the pole shield that is damaged; and replacing the at least a portion of the pole shield with at least a portion of a new pole shield that is not damaged.

According to a further aspect of the disclosure, there is provided a method of installing a utility pole assembly, comprising: forming a utility pole comprising an inner core and a laminate structure surrounding the inner core, wherein the laminate structure comprises: a reinforcing structure comprising fiber reinforcement; an outer layer surrounding the reinforcing structure; and a resin at least partially mixed with the reinforcing structure and the outer layer, wherein the resin is resistant to ultraviolet (UV) radiation, and wherein a concentration of the resin in the outer layer is greater than a concentration of the resin in the reinforcing structure; forming a pole shield; and installing the utility pole with the pole shield surrounding the utility pole.

Forming the utility pole may comprise forming the laminate structure according to a pultrusion process.

Forming the pole shield may comprise forming the pole shield according to a filament winding process.

This summary does not necessarily describe the entire scope of all aspects. Other aspects, features and advantages will be apparent to those of ordinary skill in the art upon review of the following description of specific embodiments.

### BRIEF DESCRIPTION OF THE DRAWINGS

Embodiments of the disclosure will now be described in detail in conjunction with the accompanying drawings of which:

FIGS. 1A and 1B are respectively side-on and cross-sectional views of a utility pole according to an embodiment of the disclosure;

FIG. 2 is a cross-sectional view of a laminate structure of a utility pole, according to an embodiment of the disclosure;

FIG. 3 is a partial cross-sectional view of a portion of the laminate structure of FIG. 2, according to an embodiment of the disclosure;

FIGS. 4A and 4B are respectively side-on and cross-sectional views of a utility pole assembly comprising a utility pole protected by a pole shield, according to an embodiment of the disclosure;

FIGS. 5A-5C are schematic diagrams of different pole shields, according to embodiments of the disclosure;

FIG. 6 is a cross-sectional view of a laminate structure of a pole shield, according to an embodiment of the disclosure; and

FIG. 7 is a flow diagram of a method of forming by pultrusion a laminate structure for a utility pole assembly, according to an embodiment of the disclosure.

### DETAILED DESCRIPTION

The present disclosure seeks to provide an improved utility pole assembly and an improved laminate structure for making a utility pole assembly. While various embodiments of the disclosure are described below, the disclosure is not limited to these embodiments, and variations of these embodiments may well fall within the scope of the disclosure which is to be limited only by the appended claims.

Generally, throughout this disclosure, “utility pole assembly” may refer to a utility pole surrounded by a pole shield (in which case UV protection is provided by the pole shield) or to a utility pole without a protective pole shield (in which case UV protection is provided by a laminate structure forming the utility pole).

According to at least some embodiments of the disclosure, there is described a utility pole assembly comprising a utility pole having a circular tube made of integrally UV-resistant polymer composite materials. The pole may comprise throughout an aliphatic polyurethane resin (which may be referred to throughout as an “aliphatic resin”) and fiberglass reinforcement materials formed by a pultrusion process. The pole may therefore benefit from integral UV protection without suffering from coating performance issues as seen in the prior art. Such UV resistance may extend the lifespan of the pole to within 80-100 years.

In addition, the relatively high performance of the pole may be achieved by using a composite laminate structure that may result in a pole with equivalent stiffness, superior strength, and increased durability, reliability, and resiliency when compared to equivalent wood utility poles. For example, by controlling the ratio of different fiber orientations in layers within the laminate structure, the ratio of areal weights of rovings to woven fibers and/or mats, and their relative positioning within the laminate structure, the pole may achieve both stiffness and strength characteristics comparable to equivalent wood utility poles. Furthermore, the ability to endure additional pole deflection over and above the strength of an equivalent wood pole equivalent, without breaking, enables composite poles to achieve higher reliability and resiliency than wood poles. The composite utility pole described herein may therefore enable direct replacement of equivalent wood utility poles, particularly where frequent severe storms and high wind-loading require a more reliable and resilient structure than traditional wood poles.

According to at least some embodiments, there is described a utility pole assembly comprising a utility pole and a protective pole shield surrounding the utility pole. In order to provide the required UV protection so as to enable the utility pole to benefit from a relatively long lifespan, the pole shield may be formed of a composite laminate structure comprising throughout an aliphatic resin and fiberglass reinforcement materials formed by a pultrusion process. The pole itself may comprise an aromatic polyurethane resin (which may be referred to throughout as an “aromatic resin”) and finely woven fiberglass materials formed by a pultrusion process. While an aromatic resin provides less UV protection than an aliphatic resin, aromatic resins are generally lower-cost and enable faster production rates than aliphatic resins. In the event of fire exposure, surface damage from impacts, or other events that may destroy or damage the outer protective shield, the shield can be removed and easily replaced without interrupting utility service.

According to at least some embodiments of the disclosure, there is described a laminate structure for a composite resin-fiberglass utility pole assembly. The utility pole assembly comprises a utility pole surrounding an inner core that may be entirely hollow. The utility pole assembly further comprises a laminate structure surrounding the inner core and comprising a reinforcing structure with fiber reinforcement, such as fiberglass. The laminate structure further includes a resin resistant to ultraviolet (UV) radiation and at least partially mixed with the reinforcing structure and an outer layer of the laminate structure. For example, at least a portion of, or substantially all of, the reinforcing structure may be impregnated by the resin. In addition, at least a portion of, or substantially all of, the outer layer may be impregnated by the resin. A concentration of the resin in the outer layer of the laminate structure is greater than a concentration of the resin in the reinforcing structure.

In the absence of a pole shield, the laminate structure may be used to form the utility pole itself. If a pole shield is being used, the laminate structure may be used to form the pole shield, and a different laminate structure (using for example a non-UV-resistant resin, such as an aromatic resin) may be used to form the underlying utility pole.

According to some embodiments, the reinforcing structure includes one or more fiber reinforcement layers, such as one or more woven fiberglass layers and one or more fiberglass mat layers. The one or more fiber reinforcement layers include first fabric elements (such as fiberglass strands or rovings) extending in a first direction (for example, parallel to a longitudinal axis defined by the inner core). The one or more fiber reinforcement layers include second fabric elements extending at an angle (for example, circumferentially around the longitudinal axis) to the first fabric elements. The first and second fabric elements may therefore provide strength and stiffness to the laminate structure along two separate directions. Additional fabric elements can be placed at other angles within the laminate structure, as desired. For instance, additional fabric strands or rovings may be placed at +/−45° relative to the first fabric elements and/or the second fabric elements.

According to some embodiments, the reinforcing structure includes a finely woven fiberglass fabric layer adjacent the outer layer of the laminate structure. The fiberglass fabric layer may therefore assist in ensuring that a greater proportion of the UV-resistant resin is located closer to an exterior surface of the laminate structure than to the underlying layers, and may thereby contribute to the overall improved UV performance characteristics of a utility pole assembly incorporating the laminate structure.

As a result of the laminate structure described herein, and when compared to wood utility poles, the utility pole assembly described herein may exhibit improved weatherability, including resistance to UV degradation, while exhibiting similar performance characteristics. Furthermore, the composite material may be impervious to insects, and will not be affected by rot and other natural decay processes found with wood construction materials subjected to outdoor environments.

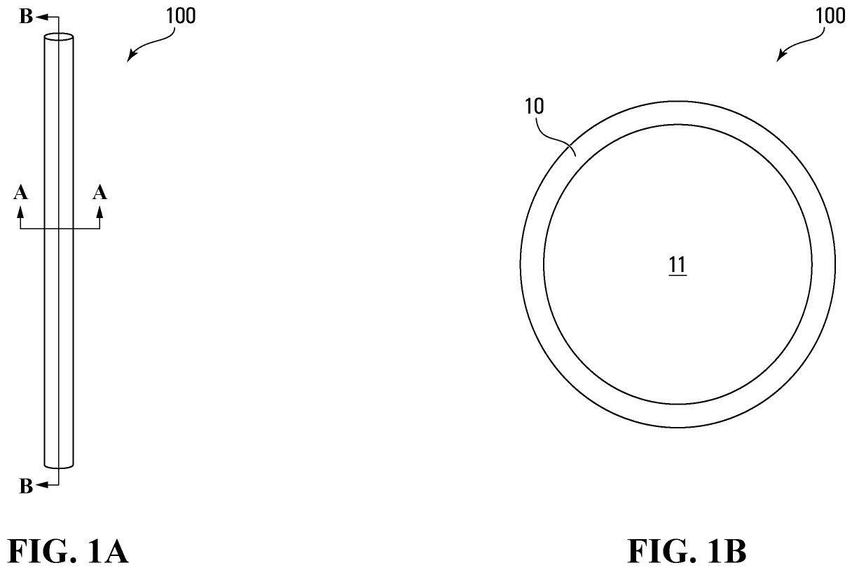

Turning to FIGS. 1A and 1B, there are shown side-on and cross-sectional views of a utility pole 100 according to an embodiment of the disclosure. In particular, FIG. 1B is a cross-sectional view of utility pole 100 take along line A-A. Pole 100 comprises an outer cylindrical laminate structure 10 formed by a pultrusion process as described in further detail below. For example, laminate structure 10 may be formed according to the pultrusion process described in US Patent Publication No. US 2009/0023870, herein incorporated by reference in its entirety. According to some embodiments, laminate structure 10 may be formed according to one or more other processes known to those of skill in the art. For example, instead of being formed according to solely a pultrusion process, laminate structure 10 may be formed by a combination of pultrusion and filament winding, or solely filament winding.

Utility pole 100 further comprises a hollow inner core 11 extending the entire length of pole 100 and surrounded by laminate structure 10. Pole 100 may be sized to any of various lengths, such as from 30 feet up to 60 feet for distribution applications, and from 60 feet to 100 feet for sub-transmission applications. While FIG. 1B shows laminate structure 10 having a cylindrical shape, laminate structure 10 may be formed according to any other suitable shape, such as a triangular, rectangular, or hexagonal shape.

Generally, in addition to a number of additional layers, laminate structure 10 comprises a mixture of fiberglass reinforcement and a UV-resistant resin. According to some embodiments, the resin is an aliphatic resin. The aliphatic resin may be a dicyclohexylmethane diisocyanate (HMDI)-terminated polyether prepolymer or an aliphatic isocyanate resin based on hexamethylene diisocyanate.

According to some embodiments, instead of fiberglass, other types of fiber reinforcement using other types of fibers may be used, such as basalt fibers or carbon fibers. According to some embodiments, the resin should withstand at least 8,000 hours of accelerated weathering in accordance with ASTM G154 (Standard Practice for Operating Fluorescent Ultraviolet (UV) Lamp Apparatus for Exposure of Nonmetallic Materials) without any significant degradation, such as blistering, cracks, checking, or flaking.

When forming laminate structure 10 according to the pultrusion process described in further detail below, the fiberglass is impregnated by the resin. Integral UV protection may therefore be present on all or substantially all surfaces of laminate structure 10. In particular, the UV resistance provided by the resin may extend from an outer surface of laminate structure 10 to inner core 11. According to some embodiments, and near the outer surface of laminate structure 10 (for example, between 0.002 and 0.010 inches from the outer surface), the composition of laminate structure 10 may be 100% resin. Gradually, as the distance from the outer surface of laminate structure 10 increases, the concentration of the resin drops to about 20%-35% by weight, once the resin enters the fiberglass fabric layer below the outermost surface of laminate structure 10.

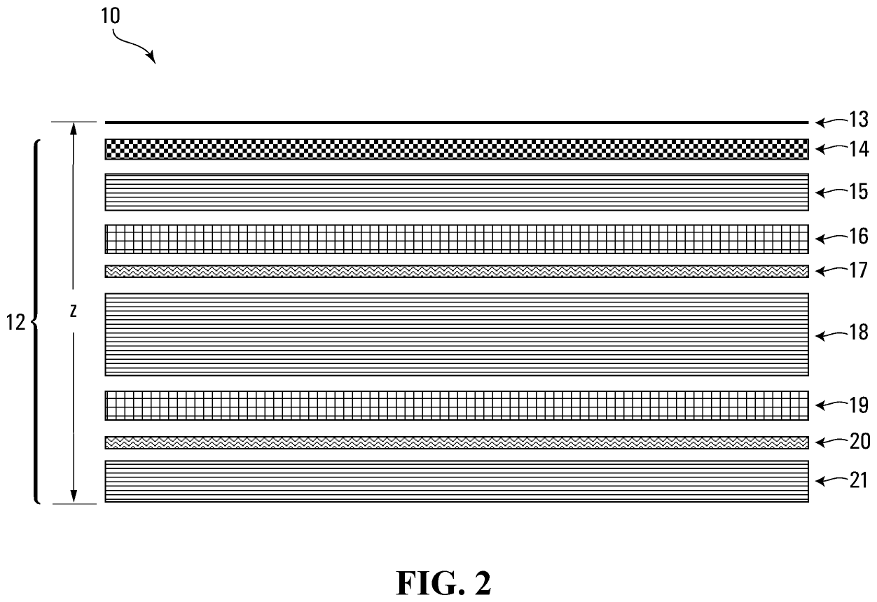

According to some embodiments, a utility pole incorporating the laminate structure as described above can be formed by pultruding a circular tube with a diameter ranging from 8 inches to 20 inches, and with a laminate structure thickness ranging from 0.2 to 0.6 inches. According to some embodiments, laminate structure 10 (an example of which is shown in FIG. 2, described in further detail below) comprises a reinforcing structure 12 with 1-4 fiberglass roving layers positioned in alternating fashion with continuous filament fiberglass mat layers, and 2-12 fiberglass reinforcement layers (either fiberglass mat layers or woven fiberglass layers). Each fiberglass mat layer comprises, in varying proportions, fibers oriented between 0 and 90 degrees relative to a longitudinal axis defined by the pole. Each fiberglass mat layer may also contain random, chopped fibers or random, continuous fibers in a mat form. Each woven fiberglass layer may include random, chopped fibers for improving processability and facilitating resin wet-out throughout the laminate structure.

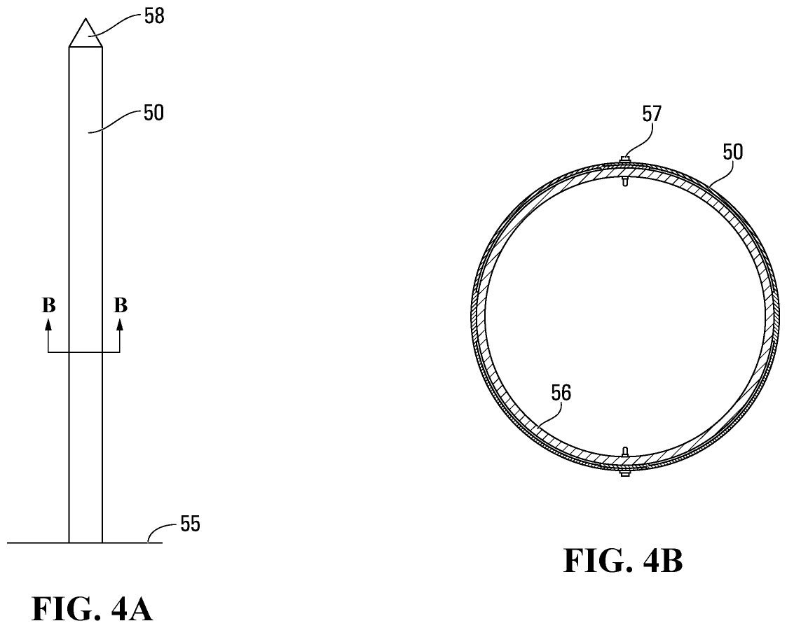

While FIGS. 1A and 1B relate to an embodiment in which the utility pole assembly does not include a pole shield and therefore the UV protection is built into the utility pole itself, according to other embodiments the UV protection may be provided by a pole shield (for example, as described below in connection with FIGS. 4A and 4B). In such cases, other types of resins may be used to form the laminate structure of the utility pole. For example, in cases where the utility pole is protected by a composite pole shield comprising an aliphatic resin, the utility pole may comprise an aromatic resin. The aromatic resin may be an aromatic resin based on polymeric diphenylmethane diisocyanate, 4,4′-diphenylmethane diisocyanate, and/or 2,4-diphenylmethane diisocyanate.

Turning to FIG. 2, there is shown a cross-sectional view of laminate structure 10 taken along line B-B seen in FIG. 1A. It should be noted that FIG. 2 is used for illustrative purposes only, and is not necessarily to scale. In addition, spacing has been included between adjacent layers, to aid in the clarity of the drawing.

As can be seen in FIG. 2, laminate structure 10 includes the following layers from an outer surface of laminate structure 10 (e.g. the surface of laminate structure 10 in contact with the exterior environment) to an interior surface of laminate structure 10 (e.g. the surface of laminate structure 10 in contact with hollow interior core 11). According to certain embodiments, the total number of layers may be adjusted, and the relative positions of the layers may be adjusted, depending on the particular desired characteristics of laminate structure 10.

From the outer surface of laminate structure 10 to the interior surface of laminate structure 10, laminate structure 10 includes the following layers: an outer resin layer 13, a finely woven fiberglass fabric layer 14, an outer fiberglass roving layer 15, an outer woven fiberglass layer 16, an outer continuous filament fiberglass mat layer 17, a central fiberglass roving layer 18, an inner woven fiberglass layer 19, an inner continuous filament fiberglass mat layer 20, and an inner fiberglass roving layer 21.

Woven fiberglass layers 16 and 19 can range in areal weights from 12-36 ounces/square yard. Woven fiberglass layers 16 and 19 provide additional structural reinforcement and, as described in further detail below, may contain unidirectional, bidirectional, or off-axis fibers (that is, fibers angled relative to the longitudinal axis of pole 100), depending on the desired design characteristics of laminate structure 10. The magnitude and proportion of the fibers extending in different directions may be varied to alter the properties of laminate structure 10 as required. For example, according to some embodiments, the ratio of fibers extending in one direction to fibers extending in another direction may be 1:1, whereas according to other embodiments the ratio may be unequal such that a disproportionate amount of fibers extend in one direction relative to the amount of fibers extending in another direction (such as 2:1, 3:1, or even 5:1).

Continuous filament fiberglass mat layers 17 and 20 can range in areal weights from 0.5 to 3.0 ounces/square yard. Continuous filament fiberglass mat layers 17 and 20 facilitate resin flow through laminate structure 10 and, during the pultrusion process, ensure proper wet-out and evacuation of any trapped air upon compression in the die.

Fiberglass roving layers 15, 18, and 21 can vary in thickness to achieve the desired strength and stiffness of laminate structure 10, and have the most influence on the bending stiffness and strength of pole 100. As can be seen in FIG. 2, fiberglass roving layers 15, 18, and 21 may be grouped into different regions dispersed throughout laminate structure 10.

Fiberglass fabric layer 14 may comprise fabric with relatively small yarns, for example from about 18×18 yarns to about 24×24 yarns per square inch. In addition, the fabric may have an areal weight from about 4 to about 10 ounces/square yard.

While the resin used within laminate structure 10 may be less than 100% aliphatic, outer resin layer 13 should preferably be 100% aliphatic, so as to ensure that pole 100 may be highly durable and may benefit from an extended lifespan in many different environments and applications. Beneath outer resin layer 13, the underlying layers in laminate structure 10 contain, according to some embodiments, 50-80% by weight of fiberglass reinforcement and 20-50% by weight of resin.

Central fiberglass roving layer 18 is stabilized by adjacent outer and inner woven fiberglass layers 16 and 19. Woven fiberglass layers 16 and 19 comprise both axial fibers extending in the longitudinal direction defined by pole 100, as well as circumferential fibers extending perpendicularly to the longitudinal axis defined by pole 100. The circumferential fibers may ensure that the radial stiffness imparted to laminate structure 10 is adequate to prevent the adjacent axial fibers from buckling prematurely under compression loading. According to some embodiments, a ratio of an areal weight of the axial fibers to the circumferential fibers may be in the range of 1:3. According to some embodiments, a combined areal weight of the axial and circumferential fibers may be about 18-36 ounces per square yard, with the areal weight of the axial fibers being about 4-12 ounces per square yard, and the areal weight of the circumferential fibers being about 9-18 ounces per square yard.

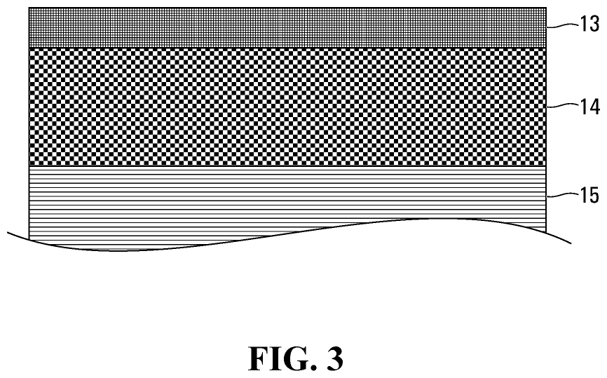

FIG. 3 is an enhanced view of a portion of laminate structure 10 close to the outermost layer of laminate structure 10, where resin-rich outer resin layer 13 (which may be 100% resin migrating to 20%-35% resin near the interface with fiberglass fabric layer 14) encapsulates laminate structure 10 and protects laminate structure 10 from environmental degradation.

Accordingly, in connection with FIGS. 1A-3, there has been described a pultruded utility pole comprising a durable, fiberglass fabric layer (e.g. fiberglass fabric layer 14). Fiberglass fabric layer 14 is based on the integration of a finely woven (i.e. small-filament yarn), lightweight fiberglass cloth. This may provide the utility pole with both an integral, non-polymer protective cloth layer, as well as a resin-rich outer layer (e.g. outer resin layer 13) above fiberglass fabric layer 14. Resin from the resin-rich outer layer may permeate through the cloth within the fiberglass fabric layer to achieve a resin-rich surface finish and containment layer that is structurally integrated to the remainder of the laminate structure. This may improve the durability of the pole relative to UV, impact, fire, and electrical arc flash situations, thereby protecting the underlying fiberglass roving layers. This in turn may eliminate or reduce the occurrence of the underlying fiberglass roving layers experiencing fiber blooming, brooming, splaying, or axial cracking that may otherwise occur from physical contact, weathering effects, or fire exposure.

In addition to incorporating an outer fiberglass fabric layer, the laminate structure of the pole includes one or more reinforcing woven fiberglass layers that may allow the pole to benefit from both strength and stiffness that are comparable to equivalent wood poles. The locations of the reinforcing woven fiberglass layers provide additional circumferential strength and stiffness. Furthermore, by placing the reinforcing woven fiberglass layers on either side and adjacent to unidirectional fiberglass roving layers at the midplane of the laminate structure, the buckling stability of the pole may be improved by limiting ovalization of the pole. In addition to increasing the circumferential stiffness of the laminate structure, the adjacent higher loading of circumferential fibers in a non-crimp textile construction provides increased lateral support to the column of axial fibers, acting like a buttress against the stiff central fiberglass roving layer.

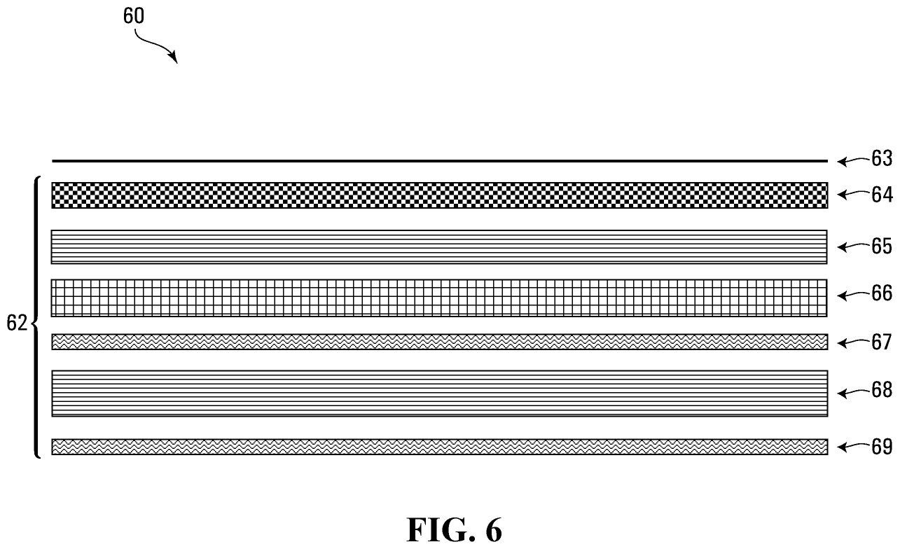

In the case where the utility pole comprises aliphatic resin (as in the embodiment of FIGS. 1A-2), outer resin layer 13 and finely woven fiberglass fabric layer 14 form the outer periphery of laminate structure 10 and are integral to the pole. In the case where the pole comprises an aromatic resin (as described for example in connection with FIGS. 4A, 4B, and 6), the outermost resin layer is still present, but the underlying finely woven fiberglass fabric layer may or may not be used.

According to further embodiments of the disclosure, there is described a utility pole assembly comprising a utility pole surrounded by a protective pole shield. In such embodiments, the utility pole may be formed using a laminate structure comprising a fiber reinforcement and resin composite. The resin used for the utility pole may be an aromatic resin. In order to provide the required UV and environmental protection, the pole shield is formed using a laminate structure also comprising a fiber reinforcement and resin composite. However, in order to provide integral UV protection to the pole shield, the resin used for the pole shield may be an aliphatic resin as described above. The pole shield may cover the entire exterior surface of the utility pole, thereby providing the same benefits of a utility pole formed using an aliphatic resin but without a pole shield.

Therefore, in cases where a pole shield is used, the UV and fire protection is primarily provided by the pole shield instead of the outer resin-rich surface of the utility pole. According to such embodiments, the outer surface of the laminate structure may comprise or consist of a non-aliphatic resin, and, for example, may comprise or consist of another type of resin such as an aromatic resin. Meanwhile, the protective shield may itself comprise an inherently UV-resistant resin, such as an aliphatic resin. The pole shied may in and of itself comprise a pultruded laminate structure that can be fastened to the utility pole using one or more post-processing techniques, such as by using self-tapping or self-drilling screws applied through the pole shield and extending into the utility pole. The pole shield may thereby be locked to the utility pole, and may conceal the aromatic resin in its entirety. According to some embodiments, instead of being pultruded, the pole shield may be formed according to one or more other manufacturing techniques. For example, the pole shield may be formed by a combination of pultrusion and filament winding, or solely filament winding. For instance, a laminate structure (such as laminate structure 60 described in further detail below) used for the pole shield may be formed by filament winding.

According to some embodiments, a utility pole protected by a pole shield may comprise both aromatic and aliphatic resins. For example, a first portion of the utility pole may be formed using an aromatic resin, and a second portion of the utility pole may be formed using an aliphatic resin. In such a case, the pole shield may be configured to extend only over that portion of the pole that includes the aromatic resin. According to still further embodiments, even with a utility pole that comprises only an aromatic resin, there may be no need for the pole shield to extend along the entirety of the length of the pole, and instead the pole shield may extend only partway along the length of the pole. For example, the pole shield may extend from ground level up to 20 feet for a 45-foot high utility pole.

FIGS. 4A and 4B show an example of a utility pole assembly comprising a utility pole protected by a pole shield. In particular, as can be seen in FIG. 4A, a protective pole shield 50 extends from the ground 55 all the way up an underlying utility pole 56 (FIG. 4B). A protective cap 58 is positioned at the upper end of pole 56. Pole shield 50 is secured to pole 56 using suitable fasteners 57 extending through pole shield 50 and pole 56. As can be seen in FIG. 4B, pole shield 50 may be formed of two or more separate pieces interconnected to one another. Protective cap 58 may be formed of a UV-resistant polymer, with its primary function being to prevent rain, critters, and insects from penetrating into pole 56.

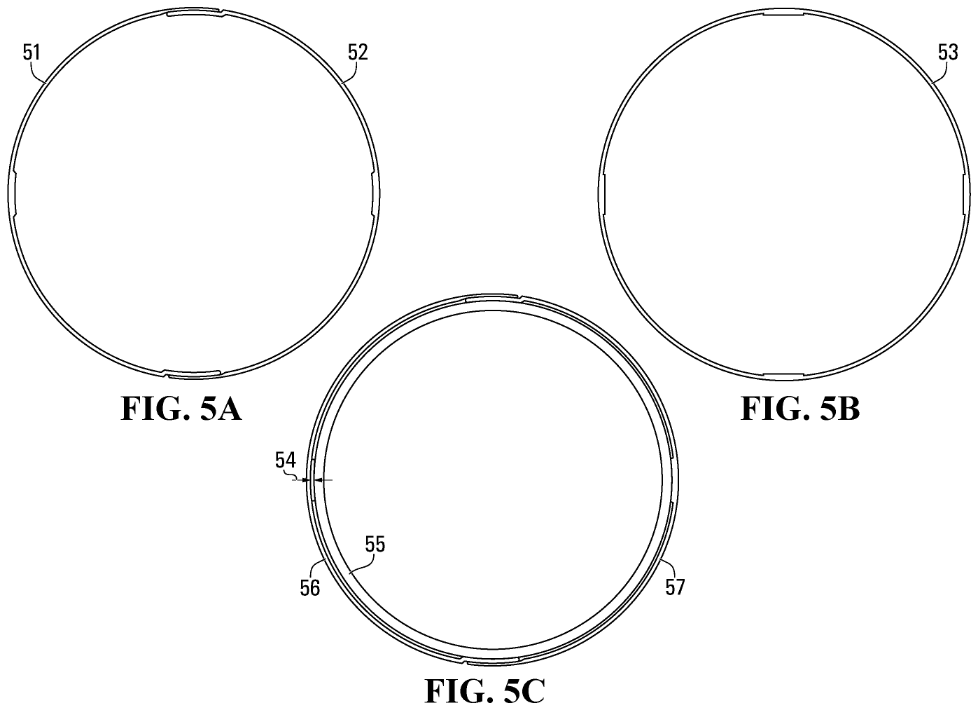

FIGS. 5A-5C illustrate different types of pole shields that may be used to protect an underlying utility pole. In particular, FIG. 5A shows a split shield comprising two interconnected and overlapping shield portions 51 and 52. FIG. 5B shows a pole shield formed of a single, unitary component 53. FIG. 5C shows a split shield (similarly to FIG. 5A) with a small gap 54 accommodated between the utility pole 55 and the shield portions 56 and 57.

Turning to FIG. 6, there is shown a laminate structure 60 that may be used to form a pole shield for protecting an underlying utility pole. Laminate structure 60 comprises a resin-rich outer layer 63 overlying a reinforcing structure 62 comprising a number of fiberglass roving layers positioned in alternating fashion with continuous filament fiberglass mat layers and woven fiberglass layers. According to certain embodiments, the total number of layers may be adjusted, and the relative positions of the layers may be adjusted, depending on the particular desired characteristics of laminate structure 60.

As can be seen in FIG. 6, from the outer surface of laminate structure 60 to the interior surface of laminate structure 60, laminate structure 60 includes the following layers: outer resin layer 63, a finely woven fiberglass fabric layer 64, an outer fiberglass roving layer 65, an outer woven fiberglass layer 66, an outer continuous filament fiberglass mat layer 67, an inner fiberglass roving layer 68, and an inner continuous filament fiberglass mat layer 69. The layers of laminate structure 60 may have the same characteristics as the corresponding layers described above in connection with laminate structure 10.

Underneath the pole shield, the laminate structure forming the utility pole may be the same as laminate structure 10 shown in FIG. 2, except that, instead of an aliphatic resin, an aromatic resin may be used, and, as discussed above, finely woven fiberglass fabric layer 614 may be dispensed with.

According to some embodiments, a weight distribution of the components forming the pole shield may be in the range of: about 0.5-2.0% by weight of finely woven fiberglass fabric; about 7-15% (in some embodiments, 11.9%) by weight of continuous filament fiberglass mats; about 50-65% by weight of fiberglass rovings; about 70-82% (in some embodiments, 77.4%) by weight of glass; and about 18-30% (in some embodiments, 22.6%) by weight of resin.

In connection with FIGS. 4A-6, there have been described embodiments in which a pole shield comprising an aliphatic resin overlies and protects a composite fiber-resin utility pole comprising an aromatic resin. In such embodiments, the laminate structure used to form the pole shield functions in much the same way as the laminate structure used to form the utility pole in the context of FIGS. 1A-3 (i.e. in embodiments without a protective pole shield). If the pole shield suffers a local impact that damages the shield, the shield may be removed in sections and a new shield may be fitted to the utility pole without removing the pole or having to reinstall the pole in the process.

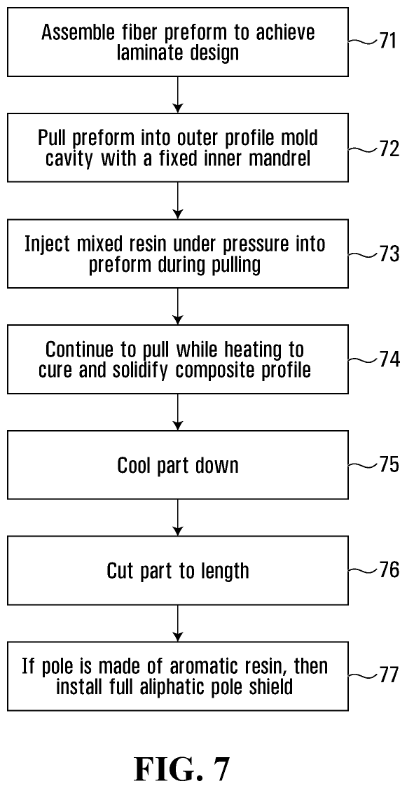

Turning to FIG. 7, there is shown a flow diagram showing a method of forming by pultrusion a fiber-resin laminate structure, according to embodiments of the disclosure.

At block 71, a fiber preform is assembled to achieve the desired laminate design. At block 72, the fiber preform is pulled into an outer profile mould cavity with a fixed inner mandrel. At block 73, while pulling the preform, resin is injected under pressure into the fiber preform from the outer profile mould and fixed inner mandrel. At block 74, while still pulling the preform, the fiber and resin mixture is progressively heated within the die cavity to cure and solidify the mixture into the final profile shape, whereby the shape becomes fully solidified with sufficient strength and can then exit the die. At block 75, the structure continues to cool down after exiting the die. At block 76, the structure has cooled sufficiently and has reached sufficient strength, and is cut to a predetermined length. At block 77, if the resin that was used at block 73 is an aromatic resin, then an aliphatic pole shield is installed over the exposed pole surface by fastening the pole shield to the utility pole. The aliphatic pole shield may be manufactured according to a similar pultrusion process as just described, with aliphatic resin used at block 73.

Developing the resin formulation must balance the need for structural performance while also achieving the correct viscosity for injection into the die, the correct viscosity for wetting out the fiberglass at high volume fraction, and the correct reactivity for curing within the die stages at the correct temperature to match the run rate. According to some embodiments, polyol blends have viscosities in the range of 500-2,000 centipoise, preferably in the range of 750-1,350 centipoise at room temperature. According to some embodiments, aliphatic isocyanate has a viscosity in the range of 150-1,500 centipoise, preferably in the range of less than 500 centipoise at room temperature. During the pultrusion, the resin-rich surface may be achieved by adjusting one or more parameters of the process, such as surface tension, resin flow and pressure, and die shape.

Secondary coating processes have an inherent bond interface between the composite and the coating which can degrade over time, and the coating itself is not integrally cured of the same material as the resin, thereby creating an inferior bond when compared to the parent structural resin. On the other hand, according to embodiments of the disclosure, the outermost resin-rich layer formed in-situ with the same resin as the underlying structure forms a protective outer layer for the laminate structure that cannot disbond, is structurally stable, durable, and (in the case of an aliphatic resin) highly UV-resistant. Such an outer protective layer will therefore enable the laminate structure to outperform secondarily-coated poles, by improving the lifespan of the laminate structure with a resin-rich layer that is integral to the structure. Examples of secondary coatings include painting, in-line coating, in-line painting, secondary material encapsulation post-exit of the die such as jacketing, flowing resin over the part, thermoplastic coating, melt sputtered coatings, and thermal spray coatings.

The word “a” or “an” when used in conjunction with the term “comprising” or “including” in the claims and/or the specification may mean “one”, but it is also consistent with the meaning of “one or more”, “at least one”, and “one or more than one” unless the content clearly dictates otherwise. Similarly, the word “another” may mean at least a second or more unless the content clearly dictates otherwise.

The terms “coupled”, “coupling” or “connected” as used herein can have several different meanings depending on the context in which these terms are used. For example, the terms coupled, coupling, or connected can have a mechanical or electrical connotation. For example, as used herein, the terms coupled, coupling, or connected can indicate that two elements or devices are directly connected to one another or connected to one another through one or more intermediate elements or devices via a mechanical element depending on the particular context. The term “and/or” herein when used in association with a list of items means any one or more of the items comprising that list.

As used herein, a reference to “about” or “approximately” a number or to being “substantially” equal to a number means being within +/−10% of that number.

While the disclosure has been described in connection with specific embodiments, it is to be understood that the disclosure is not limited to these embodiments, and that alterations, modifications, and variations of these embodiments may be carried out by the skilled person without departing from the scope of the disclosure.

It is furthermore contemplated that any part of any aspect or embodiment discussed in this specification can be implemented or combined with any part of any other aspect or embodiment discussed in this specification.

1. A utility pole assembly comprising:
a utility pole comprising an inner core; and
a laminate structure surrounding the inner core, comprising:
a reinforcing structure comprising fiber reinforcement;
an outer layer surrounding the reinforcing structure; and
a resin at least partially mixed with the reinforcing structure and the outer layer,
wherein the resin is resistant to ultraviolet (UV) radiation, and
wherein a concentration of the resin in the outer layer is greater than a concentration of the resin in the reinforcing structure.

2. The utility pole assembly of claim 1, wherein the inner core is hollow.

3. The utility pole assembly of claim 1 or 2, wherein the fiber reinforcement comprises fiberglass.

4. The utility pole assembly of any one of claims 1-3, wherein the reinforcing structure further comprises one or more fiber reinforcement layers, each fiber reinforcement layer comprising:
first fiber elements extending in a first direction; and
second fiber elements extending in a second direction at an angle to the first direction.

5. The utility pole assembly of claim 4, wherein each fiber reinforcement layer comprises woven fiberglass or a fiberglass mat.

6. The utility pole assembly of claim 4 or 5, wherein:
the first direction is parallel to a longitudinal axis defined by the utility pole; and
the second direction is perpendicular to the first direction.

7. The utility pole assembly of claim 6, wherein the second direction is a circumferential direction relative to the longitudinal axis.

8. The utility pole assembly of any one of claims 4-7, wherein the one or more fiber reinforcement layers comprise an outer fiber reinforcement layer and an inner fiber reinforcement layer.

9. The utility pole assembly of claim 8, wherein:
the reinforcing structure further comprises one or more fiberglass roving layers; and
the outer and inner fiber reinforcement layers are positioned on opposites sides of at least one of the one or more fiberglass roving layers.

10. The utility pole assembly of claim 9, wherein at least one of the outer and inner fiber reinforcement layers is in contact with the at least one of the one or more fiberglass roving layers.

11. The utility pole assembly of any one of claims 4-10, wherein, for at least one of the one or more fiber reinforcement layers, an areal weight of the first fiber elements is less than an areal weight of the second fiber elements.

12. The utility pole assembly of claim 11, wherein the areal weight of the first fiber elements relative to the second fiber elements is about 1:3.

13. The utility pole assembly of any one of claims 4-12, wherein a sum of an areal weight of the first fiber elements and an areal weight of the second fiber elements is about 24 ounces per square yard.

14. The utility pole assembly of any one of claims 1-13, wherein the reinforcing structure further comprises one or more fiberglass roving layers.

15. The utility pole assembly of claim 14, wherein:
the reinforcing structure further comprises one or more fiber reinforcement layers and one or more continuous filament mat layers; and
at least one of the one or more continuous filament mat layers is interposed between at least one of the one or more fiberglass reinforcement layers and at least one of the one or more fiberglass roving layers.

16. The utility pole assembly of claim 15, wherein the at least one of the one or more continuous filament mat layers is in contact with the at least one of the one or more fiberglass roving layers.

17. The utility pole assembly of any one of claims 1-16, wherein the reinforcing structure further comprises a fiberglass fabric layer.

18. The utility pole assembly of claim 17, wherein an areal weight of the fiberglass fabric layer is from about 4 to about 10 ounces per square yard.

19. The utility pole assembly of claim 17 or 18, wherein the fiberglass fabric layer comprises fiberglass fabric having a weave of from about 18×18 yarns to about 24×24 yarns per square inch.

20. The utility pole assembly of any one of claims 17-19, wherein the fiberglass fabric layer is in contact with the outer layer.

21. The utility pole assembly of any one of claims 1-20, wherein the laminate structure further comprises the following layers in a direction extending from an exterior surface of the laminate structure toward the inner core: the outer layer; a fiberglass fabric layer; an outer fiberglass roving layer; an outer fiber reinforcement layer; an outer continuous filament mat layer; a central fiberglass roving layer; an inner fiber reinforcement layer; an inner continuous filament mat layer; and an inner fiberglass roving layer.

22. The utility pole assembly of any one of claims 1-21, wherein the laminate structure further comprises the following layers in a direction extending from an exterior surface of the laminate structure toward the inner core: the outer layer; a fiberglass fabric layer; an outer fiberglass roving layer; a fiber reinforcement layer; an outer continuous filament mat layer; an inner fiberglass roving layer; and an inner continuous filament mat layer.

23. The utility pole assembly of any one of claims 1-22, wherein the outer layer consists of the resin.

24. The utility pole assembly of any one of claims 1-23, wherein a ratio of a weight percentage of the fiber reinforcement to a weight percentage of the resin is from 75%-82% fiber reinforcement to 18%-25% resin.

25. The utility pole assembly of any one of claims 1-24, wherein the laminate structure is formed by a pultrusion process.

26. The utility pole assembly of any one of claims 1-25, wherein the resin comprises an aliphatic polyurethane resin.

27. The utility pole assembly of any one of claims 1-26, wherein the utility pole comprises the laminate structure.

28. The utility pole assembly of claim 27, wherein the utility pole assembly does not comprise a pole shield surrounding the utility pole.

29. The utility pole assembly of any one of claims 1-26, further comprising a pole shield surrounding the utility pole, wherein the pole shield comprises the laminate structure.

30. The utility pole assembly of claim 29, wherein the pole shield is secured to the utility pole using one or more fasteners.

31. The utility pole assembly of claim 29 or 30, wherein the pole shield extends partway along a length of the utility pole.

32. The utility pole assembly of claim 29 or 30, wherein the pole shield extends along an entirely of a length of the utility pole.

33. The utility pole assembly of any one of claims 29-32, wherein the utility pole further comprises an aromatic polyurethane resin.

34. The utility pole of assembly any one of claims 29-33, wherein the utility pole further comprises:
a further laminate structure surrounding the inner core and comprising:
a further reinforcing structure comprising fiber reinforcement;
a further outer layer surrounding the further reinforcing structure; and
a further resin at least partially mixed with the further reinforcing structure and the further outer layer,
wherein a concentration of the further resin in the further outer layer is greater than a concentration of the further resin in the further reinforcing structure.

35. The utility pole assembly of claim 34, wherein the further resin comprises an aromatic polyurethane resin.

36. The utility pole of claim 35, wherein the pole shield is formed by a filament winding process, and wherein the utility pole is formed by a pultrusion process.

37. The utility pole assembly of any one of claims 29-36, wherein the pole shield is formed by a filament winding process.

38. A laminate structure for a utility pole assembly, comprising:
a reinforcing structure comprising fiber reinforcement;
an outer layer overlying the reinforcing structure; and
a resin at least partially mixed with the reinforcing structure and the outer layer,
wherein the resin is resistant to ultraviolet (UV) radiation, and
wherein a concentration of the resin in the outer layer is greater than a concentration of the resin in the reinforcing structure.

39. A method of making a laminate structure, comprising:
providing a fiber preform comprising fiber reinforcement;
pulling the preform over a mandrel located inside a cavity of a die, so as to mould the preform;
during the pulling, injecting a resin into the preform such that the resin is at least partially mixed with the preform, wherein the resin is resistant to ultraviolet (UV) radiation; and
after the pulling and the injecting, allowing the preform to cure into a laminate structure surrounding a hollow inner core and comprising an outer layer overlying one or more layers of the fiber reinforcement,
wherein, after the curing, a concentration of the resin in the outer layer is greater than a concentration of the resin in the one or more layers of the fiber reinforcement.

40. A method of repairing a utility pole assembly, the utility pole assembly comprising:
a utility pole comprising an inner core; and
a pole shield surrounding the utility pole and comprising:
a reinforcing structure comprising fiber reinforcement;
an outer layer surrounding the reinforcing structure; and
a resin at least partially mixed with the reinforcing structure and the outer layer, wherein:
the resin is resistant to ultraviolet (UV) radiation; and
a concentration of the resin in the outer layer is greater than a concentration of the resin in the reinforcing structure,
wherein the method comprises:
removing at least a portion of the pole shield that is damaged; and
replacing the at least a portion of the pole shield with at least a portion of a new pole shield that is not damaged.

41. A method of installing a utility pole assembly, comprising:
forming a utility pole comprising an inner core and a laminate structure surrounding the inner core, wherein the laminate structure comprises:
a reinforcing structure comprising fiber reinforcement;
an outer layer surrounding the reinforcing structure; and
a resin at least partially mixed with the reinforcing structure and the outer layer,
wherein the resin is resistant to ultraviolet (UV) radiation, and
wherein a concentration of the resin in the outer layer is greater than a concentration of the resin in the reinforcing structure;
forming a pole shield; and
installing the utility pole with the pole shield surrounding the utility pole.

42. The method of claim 41, wherein:
forming the utility pole comprises forming the laminate structure according to a pultrusion process; and
forming the pole shield comprises forming the pole shield according to a filament winding process.
